(19) United States
(12) Patent Application Publication
(10) Pub. No.: US 2022/0158181 A1
(43) Pub. Date: May 19, 2022

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Yukiho Okuno, Osaka (JP); Takahiro Fukuoka, Osaka (JP); Tasuku Ishiguro, Osaka (JP); Masahiro Soga, Osaka (JP)

(73) Assignee: Panasonic Intellectual Property Management Co., Ltd., Osaka-shi, Osaka (JP)

(21) Appl. No.: 17/442,154

(22) PCT Filed: Mar. 2, 2020
(86) PCT No.: PCT/JP2020/008645

§ 371 Date: Sep. 23, 2021

(30) Foreign Application Priority Data
Mar. 28, 2019 (JP) 2019-063662

(51) Int. Cl. H01M 4/38; H01M 10/0525; H01M 4/36; H01M 4/587; H01M 4/134

(52) U.S. Cl. CPC H01M 4/386; H01M 10/0525; H01M 2004/027; H01M 4/587; H01M 4/134; H01M 4/364

(57) ABSTRACT

A negative electrode material mixture with a negative electrode active material including a Si-containing material and a carbon material; and a carbon nanotube. The Si-containing material includes, a first composite material in which Si particles are dispersed in a lithium silicate phase and/or a carbon phase, and a second composite material in which Si particles are dispersed in a SiO₂ phase, at least the first composite material. A mass ratio X of the first composite material to a total of the first and second composite materials, and a mass ratio Y of the total of the first second composite materials to a total of the first composite material, the second composite material, and the carbon material satisfy a relational expression (1): 100Y−32.2X⁵+65.479X⁴−55.832X³+18.116X²−6.9275X−3.5356<0, X≤1, and 0.06≤Y. The non-aqueous electrolyte includes LiPF₆ and LiN(SO₂F)₂.

### TECHNICAL FIELD

The present invention relates to a non-aqueous electrolyte secondary battery in which a silicon-containing material is used for a negative electrode active material.

### BACKGROUND ART

A non-aqueous electrolyte secondary battery typified by a lithium ion secondary battery includes a positive electrode, a negative electrode, and a non-aqueous electrolyte. The negative electrode includes a negative electrode material mixture including a negative electrode active material capable of electrochemically absorbing and desorbing lithium ions. The use of a high-capacity silicon-containing material for the negative electrode active material has been investigated.

PTL 1 proposes the use of a silicon-containing material including a lithium silicate phase represented by Li₂ᵤSiO₂+u (0<u<2), and silicon particles dispersed in the lithium silicate phase for the negative electrode active material.

Investigations also have been carried out on conductive agents, and PTL 2 proposes using, as the conductive agent of a negative electrode, a carbon nanotube (CNT) with a covering layer including metallic lithium formed on the surface thereof.

### CITATION LIST

### Patent Literature

PTL 1: WO 2016/035290

PTL 2: Japanese Laid-Open Patent Publication No. 2015-138633

### SUMMARY OF INVENTION

### Technical Problem

It is contemplated that a silicon-containing material including silicon particles and a CNT are included in the negative electrode material mixture. The silicon particles crack with expansion and contraction of the silicon particles during charge and discharge, or gaps are formed around the silicon particles with contraction of the silicon particles. Accordingly, the isolation of the silicon particles tend to occur. In the initial period of cycles, even if the silicon particles are isolated, the conductive path is secured by the CNT, and the capacity is maintained.

However, as the silicon particles are isolated, their active surface tends to be exposed, and the active surface and the non-aqueous electrolyte may come into contact with each other, resulting in side reactions. When the negative electrode material mixture includes a CNT, side reactions are likely to occur. Accordingly, in and after the middle stage of cycles, corrosion and degradation of the composite material due to the side reactions tend to proceed, so that the capacity is likely to be reduced.

### Solution to Problem

In view of the foregoing, an aspect of the present invention relates to a non-aqueous electrolyte secondary battery including: a positive electrode; a negative electrode; and a non-aqueous electrolyte, wherein the negative electrode includes a negative electrode material mixture including: a negative electrode active material including a silicon-containing material and a carbon material; and a carbon nanotube, the silicon-containing material includes, of a first composite material and a second composite material, at least the first composite material, the first composite material includes a lithium ion conductive phase, and silicon particles dispersed in the lithium ion conductive phase, the lithium ion conductive phase including a silicate phase and/or a carbon phase, the silicate phase including at least one selected from the group consisting of alkali metal elements and Group 2 elements, the second composite material includes a SiO₂ phase, and silicon particles dispersed in the SiO₂ phase, a mass ratio X of the first composite material to a total of the first composite material and the second composite material, and a mass ratio Y of the total of the first composite material and the second composite material to a total of the first composite material, the second composite material, and the carbon material satisfy a relational expression (1):

100Y−32.2X⁵+65.479X⁴−55.832X³+18.116X²−6.9275X−3.5356<0, X≤1, and 0.06≤Y, and the non-aqueous electrolyte includes lithium hexafluorophosphate and lithium bis(fluorosulfonyl)imide: LFSI.

### Advantageous Effects of Invention

According to the present invention, it is possible to improve the cycle characteristics of a non-aqueous electrolyte secondary battery including a negative electrode including a silicon-containing material.

While the novel features of the invention are set forth in the appended claims, the invention, both as to organization and content, will be better understood and appreciated, along with other objects and features thereof, from the following detailed description taken in conjunction with the drawings.

### BRIEF DESCRIPTION OF DRAWING

FIG. 1 is a partially cut-away, schematic oblique view of a non-aqueous electrolyte secondary battery according to an embodiment of the present invention.

### DESCRIPTION OF EMBODIMENT

A non-aqueous electrolyte secondary battery according to an embodiment of the present invention includes a positive electrode, a negative electrode, and a non-aqueous electrolyte. The negative electrode includes a negative electrode material mixture including a negative electrode active material capable of electrochemically absorbing and desorbing lithium ions, and a carbon nanotube (hereinafter referred to as a “CNT”). The negative electrode active material includes a silicon-containing material and a carbon material.

The silicon-containing material includes, of a first composite material and a second composite material, at least the first composite material. With the first composite material, it is possible to obtain a high capacity. The first composite material includes a lithium ion conductive phase, and silicon particles dispersed in the lithium ion conductive phase, and the lithium ion conductive phase includes a silicate phase and/or a carbon phase. The silicate phase includes at least one selected from the group consisting of alkali metal elements and Group 2 elements.

The second composite material includes a SiO₂ phase, and silicon particles dispersed in the SiO₂ phase. The silicon particles of the first composite material have a larger average particle size than the silicon particles of the second composite material, and are likely to be isolated with expansion and contraction during charge and discharge.

Amass ratio X of the first composite material to a total of the first composite material and the second composite material, and a mass ratio Y of the total of the first composite material and the second composite material to a total of the first composite material, the second composite material, and the carbon material satisfy the following relational expression (1):

100Y−32.2X⁵+65.479X⁴−55.832X³+18.116X²−6.9275X−3.5356<0,X≤1, and 0.06≤Y (1)

The non-aqueous electrolyte includes lithium hexafluorophosphate (LiPF₆), and lithium bis(fluorosulfonyl)imide (LiN(SO₂F)₂) (hereinafter referred to as “LFSI”). With the use of LiPF₆, a non-aqueous electrolyte having a wide potential window and a high electrical conductivity is obtained. In addition, a passive film is likely to be formed on the surface of constituent members of the battery, such as a positive electrode current collector, so that corrosion of the positive electrode current collector and the like is suppressed.

When a CNT is included in the negative electrode material mixture including the first composite material, the conductive path of the isolated silicon particles is secured. However, on the other hand, corrosion and degradation of the first composite material due to side reactions between the silicon particles (active surface) and the non-aqueous electrolyte are likely to proceed. Hydrogen fluoride, which is generated by the reaction between LiPF₆ included in the non-aqueous electrolyte and a trace amount of water included in the battery, participates in the above-described side reactions, and the CNT promotes the reaction between the LiPF₆ and the water.

In contrast, according to the present invention, LFSI is included in the non-aqueous electrolyte as a lithium salt, together with LiPF₆. LFSI is less likely to generate hydrogen fluoride even when coming into contact with water, and can form a good coating (SEI. Solid Electrolyte Interface) on the surface of the particles of the first composite material. With the use of LFSI, it is possible to reduce the concentration of LiPF₆. Even when a portion of LiPF₆ in the non-aqueous electrolyte is substituted with LFSI, it is possible to maintain the non-aqueous electrolyte having a wide potential window and high electrical conductivity. The use of LFSI makes it possible to suppress corrosion and degradation of the first composite material due to the above-described side reactions in the case of using the negative electrode material mixture including the first composite material and the CNT. Accordingly, it is possible to maintain a high capacity in and after the middle stage of cycles.

The silicon-containing material may further include a second composite material. However, from the viewpoint of increasing the capacity and improving the cycle characteristics, the mass ratio X needs to satisfy the relational expression (1). The second composite material has a smaller capacity than the first composite material, but is advantageous in that it undergoes less expansion during charge.

By using the silicon-containing material and the carbon material in combination for the negative electrode active material, it is possible to achieve stable cycle characteristics. However, from the viewpoint of improving the cycle characteristics, it is necessary that the mass ratio Y satisfies the relational expression (1). When Y is 0.06 or more, the effect of the silicon-containing material in increasing the capacity is sufficiently achieved. Y is preferably 0.06 or more and 0.14 or less. In this case, an increase in capacity and improvement in cycle characteristics can be easily achieved at the same time.

From the viewpoint of further improving the cycle characteristics in and after the middle stage, it is preferable that the mass ratio X and the mass ratio Y satisfy the following relational expression (2).

100Y−2.1551×exp(1.3289X)<0,X≤1, and 0.06≤Y (2)

### (CNT)

In the case of using a CNT for the conductive agent, a significant effect of securing the conductive path of the isolated silicon particles is achieved. Since the CNT is fibrous, contact points between the isolated silicon particles and the negative electrode active material present therearound are more easily secured than in the case of spherical conductive particles such as acetylene black. Accordingly, the conductive path is easily formed between the isolated silicon particles and the negative electrode active material present therearound.

From the viewpoint of securing the conductive path of the isolated silicon particles, the average length of the CNT is preferably 1 μm or more and 100 μm or less, and more preferably 5 μm or more and 20 μm or less. Similarly, the average diameter of the CNT is preferably 1.5 nm or more and 50 nm or less, and more preferably 1.5 nm or more and 20 nm or less.

The average length and the average diameter of the CNT are determined by image analysis using a scanning electron microscope (SEM). Specifically, the average length and the average diameter are determined by arbitrarily selecting a plurality of (e.g., about 100 to 1000) CNTs, then measuring the lengths and the diameters thereof, and averaging the measured values. Note that the length of a CNT refers to the length when the CNT is in a straight form.

From the viewpoint of securing the conductive path of the isolated silicon particles and suppressing corrosion and degradation of the first composite material, the content of the CNT in the negative electrode material mixture may be 0.1 mass % or more and 0.5 mass % or less, or 0.1 mass % or more and 0.4 mass % or less, relative to the whole of the negative electrode material mixture. When the content of the CNT in the negative electrode material mixture is 0.1 mass % or more relative to the whole of the negative electrode material mixture, the cycle characteristics are easily improved. When the content of the CNT in the negative electrode material mixture is 0.5 mass % or less relative to the whole of the negative electrode material mixture, corrosion and degradation of the first composite material are easily suppressed. Examples of the analysis method of the CNT include Raman spectrometry and thermogravimetric analysis.

### (Non-Aqueous Electrolyte)

The non-aqueous electrolyte includes LiPF₆ and LFSI as lithium salts that are dissolved in anon-aqueous solvent. From the viewpoint of improving the cycle characteristics in and after the middle stage, the concentration of the LFSI in the non-aqueous electrolyte is preferably 0.2 mol/L or more, more preferably 0.2 mol/L or more and 1.1 mol/L or less, and even more preferably 0.2 mol/L or more and 0.4 mol/L or less. From the viewpoint of sufficiently achieving the effect of LiPF₆, the concentration of the LiPF₆ in the non-aqueous electrolyte is preferably 0.3 mol/L or more. From the viewpoint of suppressing corrosion and degradation of the first composite material, the concentration of the LiPF₆ in the non-aqueous electrolyte is preferably 1.3 mol/L or less. From the viewpoint of sufficiently achieving the effect of the combined use of LFSI and LiPF₆, the total concentration of the LFSI and the LiPF₆ in the non-aqueous electrolyte is preferably 1 mol/L or more and 2 mol/L or less.

From the viewpoint of achieving the effect of LFSI and the effect of LiPF₆ in a well-balanced manner, the proportion of the LFSI in the total of the LFSI and the LiPF₆ in the lithium salts is preferably 5 mol % or more and 90 mol % or less, and more preferably 10 mol % or more and 30 mol % or less. Although another lithium salt may be further included as the lithium salts, in addition to LFSI and LiPF₆, the proportion of the total of the LFSI and the LiPF₆ in the lithium salts is preferably 80 mol % or more, and more preferably 90 mol % or more. By controlling the proportion of the total of the LFSI and the LiPF₆ in the lithium salts within the above-described range, a battery having excellent cycle characteristics can be easily obtained. As the method for analyzing the lithium salts (LFSI and LiPF₆) in the non-aqueous electrolyte, it is possible to use, for example, nuclear magnetic resonance (NMR), ion chromatography (IC), gas chromatography (GC), or the like.

### (Negative Electrode Active Material)

The negative electrode active material includes a silicon-containing material capable of electrochemically absorbing and desorbing lithium ions. The silicon-containing material is advantageous in increasing the capacity of a battery. The silicon-containing material includes at least a first composite material.

### (First Composite Material)

The first composite material includes a lithium ion conductive phase, and silicon particles dispersed in the lithium ion conductive phase, and the lithium ion conductive phase includes a silicate phase and/or a carbon phase. The silicate phase includes at least one selected from the group consisting of alkali metal elements and Group 2 elements. That is, the first composite material includes at least one of a composite material (hereinafter also referred to as an “LSX material”) including a silicate phase and silicon particles dispersed in the silicate phase, and a composite material (hereinafter also referred to as a “Si—C material”) including a carbon phase and silicon particles dispersed in the carbon phase. By controlling the amount of the silicon particles dispersed in the lithium ion conductive phase, it is possible to increase the capacity. The stress generated with expansion and contraction of the silicon particles during charge and discharge is relaxed by the lithium ion conductive phase. Therefore, the first composite material is advantageous in achieving an increased capacity and improved cycle characteristics of a battery. The silicate phase has a small number of sites that can react with lithium and has high initial charge and discharge efficiency, and therefore is superior to the carbon phase as the lithium ion conductive phase.

From the viewpoint of increasing the capacity, the average particle size of the silicon particles before the initial charge is usually 50 nm or more, and preferably 100 nm or more. The LSX material can be produced, for example, by grinding a mixture of silicate and a silicon raw material into fine particles, using a grinding apparatus such as a ball mill, followed by heat-treating the fine particles in an inert atmosphere. The LSX material may also be produced by synthesizing fine particles of silicate and fine particles of the silicon raw material without using a grinding apparatus, and heat-treating a mixture thereof in an inert atmosphere. By adjusting the blending ratio between the silicate and the silicon raw material, and the particle size of the silicon raw material in the above-described process, it is possible to control the amount and the size of the silicon particles to be dispersed in the silicate phase, thus easily increasing the capacity.

From the viewpoint of suppressing cracking of the silicon particles, the average particle size of the silicon particles before the initial charge is preferably 500 nm or less, and more preferably 200 nm or less. After the initial charge, the average particle size of the silicon particles is preferably 400 nm or less. By micronizing the silicon particles, the volume change during charge and discharge is reduced, and the structural stability of the first composite material is further improved.

The average particle size of the silicon particles is measured using a cross-sectional image of the first composite material, obtained using a scanning electron microscope (SEM). Specifically, the average particle size of the silicon particles is determined by averaging the maximum diameters of arbitrarily selected 100 silicon particles.

Each of the silicon particles dispersed in the lithium ion conductive phase has a particulate phase of a simple substance of silicon (Si), and is usually composed of a single or a plurality of crystallites. The crystallite size of the silicon particles is preferably 30 nm or less. When the crystallite size of the silicon particles is 30 nm or less, it is possible to reduce the amount of volume change caused by expansion and contraction of the silicon particles during charge and discharge, thus further improving the cycle characteristics. For example, the isolation of silicon particles due to a reduction of contact points between the silicon particles and the surroundings as a result of formation of voids in the surroundings of the silicon particles during contraction of the particles is suppressed, so that a reduction in charge and discharge efficiency due to the isolation of the particles is suppressed. The lower limit value of the crystallite size of the silicon particles is not particularly limited, but is, for example, 5 nm or more.

The crystallite size of the silicon particles is more preferably 10 nm or more and 30 nm or less, and even more preferably 15 nm or more and 25 nm or less. When the crystallite size of the silicon particles is 10 nm or more, the surface area of the silicon particles can be kept small, and therefore the silicon particles are less likely to undergo degradation accompanied by generation of an irreversible capacity.

The crystallite size of the silicon particles is calculated from the half-width of a diffraction peak attributed to the Si (111) plane in an X-ray diffraction (XRD) pattern of the silicon particles, using the Scherrer equation.

From the viewpoint of increasing the capacity, the content of the silicon particles in the first composite material is preferably 30 mass % or more, more preferably 35 mass % or more, and even more preferably 55 mass % or more. This results in good lithium ion diffusivity, making it possible to easily achieve excellent load characteristics. On the other hand, from the viewpoint of improving the cycle characteristics, the content of the silicon particles in the first composite material is preferably 95 mass % or less, more preferably 75 mass % or less, and even more preferably 70 mass % or less. This results in a reduction in the area of the surface of the silicon particles that is exposed without being covered with the lithium ion conductive phase, so that reactions between the electrolytic solution and the silicon particles are easily suppressed.

The content of the silicon particles can be measured by Si-NMR In the following, desirable measurement conditions for Si-NMR will be described.

Measurement apparatus: a solid-state nuclear magnetic resonance spectrometer (INOVA-400), manufactured by Varian Inc.

Probe: Varian 7 mm CPMAS-2

MAS: 4.2 kHz

MAS rate: 4 kHz

Pulse: DD (45° pulse+signal acquisition time 1H decoupling)

Repetition time: 1200 sec

Observation width: 100 kHz

Center of observation: approximately −100 ppm

Signal acquisition time: 0.05 sec

Number of times of integrations: 560

Sample amount: 207.6 mg

The silicate phase includes at least one of an alkali metal element (a Group 1 element other than hydrogen in the long-form periodic table) and a Group 2 element in the long-form periodic table. The alkali metal element includes lithium (Li), potassium (K), sodium (Na), and the like. The Group 2 element includes magnesium (Mg), calcium (Ca), barium (Ba), and the like. Among these, a silicate phase including lithium (hereinafter also referred to as a “lithium silicate phase”) is preferable because of the small irreversible capacity and the high initial charge and discharge efficiency. That is, the LSX material is preferably a composite material including a lithium silicate phase, and silicon particles dispersed in the lithium silicate phase.

The silicate phase is, for example, a lithium silicate phase (oxide phase) including lithium (Li), silicon (Si), and oxygen (O). The atomic ratio: O/Si of O to Si in the lithium silicate phase is, for example, greater than 2 and less than 4. A ratio of O/Si of greater than 2 and less than 4 (z in the formula below satisfies 0<z<2) is advantageous in stability and lithium ion conductivity. Preferably, O/Si is greater than 2 and less than 3 (z in the formula below satisfies 0<z<1). The atomic ratio: Li/Si of Li to Si in the lithium silicate phase is, for example, greater than 0 and less than 4. The lithium silicate phase may include, in addition to Li, Si, and O, a trace amount of other elements such as iron (Fe), chromium (Cr), nickel (Ni), manganese (Mn), copper (Cu), molybdenum (Mo), zinc (Zn), and aluminum (Al).

The lithium silicate phase may have a composition represented by the formula: Li_{2z}SiO_{2+z} (0<z<2). From the viewpoint of the stability, the ease of fabrication, the lithium ion conductivity, and the like, z preferably satisfies a relationship of 0<z<1, and more preferably satisfies z=½.

The lithium silicate phase of LSX has a smaller number of sites that can react with lithium, as compared with the SiO₂ phase of SiOₓ. Therefore, LSX is less likely to produce an irreversible capacity due to charge and discharge, as compared with SiOₓ. In the case of dispersing silicon particles in the lithium silicate phase, excellent charge and discharge efficiency is achieved in the initial stage of charge and discharge. In addition, the content of the silicon particles can be freely changed, and it is thus possible to design a negative electrode having a high capacity.

The composition of the silicate phase of the first composite material can be analyzed, for example, by the following method.

The battery is disassembled, and the negative electrode is taken out and washed with anon-aqueous solvent such as ethylene carbonate. After drying, across section of the negative electrode material mixture layer is processed using a cross section polisher (CP), to obtain a sample. A backscattered electron image of the cross section of the sample was obtained using a field emission scanning electron microscope (FE-SEM), and the cross-section of the first composite material is observed. For the silicate phase of the observed first composite material, qualitative and quantitative analysis of the elements is performed using an Auger electron spectroscopy (AES) analyzer (acceleration voltage: 10 kV, beam current: 10 nA). For example, the composition of the lithium silicate phase is determined based on the obtained contents of lithium (Li), silicon (Si), oxygen (O), and other elements.

Note that the first composite material and the second composite material can be differentiated from each other on the cross section of the sample. Usually, the average particle size of the silicon particles in the first composite material is larger than the average particle size of the silicon particles in the second composite material, and the two composite materials can be easily differentiated from each other through observation of the particle diameters.

For the cross-section observation and analysis of the sample described above, a carbon sample stage may be used for fixing the sample in order to prevent the diffusion of Li. In order to prevent degeneration of the cross section of the sample, a transfer vessel that holds and transports the sample without exposing the sample to the atmosphere may be used.

The carbon phase may be composed of, for example, amorphous carbon having low crystallinity. The amorphous carbon may be, for example, hard carbon, soft carbon, or amorphous carbon other than these. The amorphous carbon can be obtained, for example, by sintering a carbon source under an inert atmosphere, and grinding the resulting sintered body. A Si—C material can be obtained, for example, by mixing a carbon source and a silicon raw material, stirring the mixture while crushing, using a stirrer such as a ball mill, followed by firing the mixture in an inert atmosphere. As the carbon source, it is possible to use, for example, saccharides and a water-soluble resin and the like, such as carboxymethyl cellulose (CMC), polyvinyl pyrrolidone, cellulose, and sucrose. When mixing the carbon source and the silicon raw material, the carbon source and the silicon raw material may be dispersed in a dispersing medium such as alcohol, for example. By adjusting the blending ratio between the carbon source and the silicon raw material, and the particle size of the silicon raw material in the above-described process, it is possible to control the amount and the size of the silicon particles to be dispersed in the carbon phase, thus easily increasing the capacity.

It is preferable that the first composite material forms a particulate material (hereinafter also referred to as “first particles”) having an average particle size of 1 to 25 μm, and more preferably 4 to 15 μm. Within the above-described particle size range, the stress generated due to volume change of the first composite material during charge and discharge is easily reduced, so that favorable cycle characteristics are easily achieved. The first particles also have an appropriate surface area, so that a decrease in the capacity caused by side reactions with the electrolytic solution is also suppressed.

The average particle size of the first particles means a particle size (volume average particle size) with which an accumulated volume value is 50% in a particle size distribution measured by laser diffraction/scattering. As the measurement apparatus, it is possible to use, for example, an “LA-750” manufactured by HORIBA, Ltd.

The first particles may include a conductive material that coats at least a portion of the surface thereof. The silicate phase has poor electron conductivity, and therefore the first particles also tend to have low conductivity. The conductivity can be dramatically increased by coating the surface of the first particles with the conductive material. Preferably, the conductive layer has a thickness small enough not to substantially affect the average particle size of the first particles.

### (Second Composite Material)

The silicon-containing material may further include a second composite material including a SiO₂ phase, and silicon particles dispersed in the SiO₂ phase. The second composite material is represented by SiOₓ, where x is, for example, about 0.5 or more and about 1.5 or less. The second composite material is obtained by heat-treating silicon monoxide, and separating the silicon monoxide into a SiO₂ phase and a fine Si phase (silicon particles) dispersed in the SiO₂ phase through disproportionation. In the case of the second composite material, the silicon particles are smaller than those in the case of the first composite material, and the average particle size of the silicon particles in the second composite material is, for example, about 5 nm. In the case of the second composite material, the silicon particles are smaller, and therefore the extent of improvement in the cycle characteristics achieved by the use of the LFSI is smaller than in the case of the first composite material. From the viewpoint of increasing the capacity and improving the cycle characteristics, the mass ratio of the second composite material to the total of the first composite material and the second composite material satisfies (1−X).

### (Carbon Material)

The negative electrode active material may further include a carbon material capable of electrochemically absorbing and desorbing lithium ions. The carbon material has a smaller degree of expansion and contraction during charge and discharge than the silicon-containing material. By using the silicon-containing material and the carbon material in combination, the state of contact between the negative electrode active material particles and between the negative electrode material mixture layer and the negative electrode current collector can be more favorably maintained during repeated charge and discharge. That is, it is possible to improve the cycle characteristics while providing the high capacity of the silicon-containing material to the negative electrode. From the viewpoint of increasing the capacity and improving the cycle characteristics, the mass ratio of the carbon material to the total of the first composite material, the second composite material, and the carbon material satisfies (1−Y). Note that when the first composite material includes a carbon phase as the lithium ion conductive phase, the carbon phase serving as the lithium ion conductive phase is not included in the mass of the carbon material.

Examples of the carbon material used for the negative electrode active material include graphite, graphitizable carbon (soft carbon), and hardly graphitizable carbon (hard carbon). Among these, graphite, which is excellent in charge and discharge stability and has a small irreversible capacity, is preferable. Graphite means a material having a graphite crystal structure, and includes, for example, natural graphite, artificial graphite, and graphitized mesophase carbon particles. The carbon materials may be used alone or in a combination of two or more.

In the following, the non-aqueous electrolyte secondary battery will be described in detail.

### [Negative Electrode]

The negative electrode may include a negative electrode current collector, and a negative electrode material mixture layer supported on a surface of the negative electrode current collector. The negative electrode material mixture layer can be formed by applying, to the surface of the negative electrode current collector, a negative electrode slurry in which the negative electrode material mixture is dispersed in a dispersing medium, and drying the slurry. The resulting dried coating film may be rolled as needed. The negative electrode material mixture layer may be formed on one surface of the negative electrode current collector, or may be formed on both surfaces thereof.

The negative electrode material mixture includes a negative electrode active material and a CNT as essential components. The negative electrode material mixture can include a binder, a conductive agent other than the CNT, a thickener, and the like as optional components.

A non-porous conductive substrate (a metal foil, etc.), or a porous conductive substrate (a mesh structure, a net structure, a punched sheet, etc.) is used as the negative electrode current collector. Examples of the material of the negative electrode current collector include stainless steel, nickel, a nickel alloy, copper, and a copper alloy. The thickness of the negative electrode current collector is not particularly limited, but is preferably 1 to 50 μm, and more desirably 5 to 20 μm.

Examples of the binder include resin materials, including, for example, fluorocarbon resins such as polytetrafluoroethylene and polyvinylidene fluoride (PVDF); polyolefin resins such as polyethylene and polypropylene; polyamide resins such as aramid resin; polyimide resins such as polyimide and polyamide imide; acrylic resins such as polyacrylic acid, polymethyl acrylate, and an ethylene-acrylic acid copolymer; vinyl resins such as polyacrylonitrile and polyvinyl acetate; polyvinyl pyrrolidone; polyethersulfone; and rubber-like materials such as a styrene-butadiene copolymer rubber (SBR). The binders may be used alone or in a combination of two or more.

Examples of the conductive agent other than the CNT include carbons such as acetylene black; conductive fibers such as carbon fibers and metal fibers; carbon fluoride; metal powders such as aluminum; conductive whiskers such as zinc oxide and potassium titanate; conductive metal oxides such as titanium oxide; and organic conductive materials such as phenylene derivatives. The conductive agents may be used alone or in a combination of two or more.

Examples of the thickener include cellulose derivatives (cellulose ether, etc.) such as carboxymethyl cellulose (CMC) and modified products thereof (also including salts such as a Na salt), and methylcellulose; a saponified product of a polymer having a vinyl acetate unit such as polyvinyl alcohol; and polyether (polyalkylene oxide such as polyethylene oxide). The thickeners may be used alone or in a combination of two or more.

Examples of the dispersing medium include, but are not limited to, water, alcohol such as ethanol, ether such as tetrahydrofuran, amide such as dimethylformamide, N-methyl-2-pyrrolidone (NMP), and solvent mixtures thereof.

### [Positive Electrode]

The positive electrode may include a positive electrode current collector, and a positive electrode material mixture layer supported on a surface of the positive electrode current collector. The positive electrode material mixture layer can be formed by applying, to the surface of the positive electrode current collector, a positive electrode slurry in which the positive electrode material mixture is dispersed in a dispersing medium, and drying the slurry. The resulting dried coating film may be rolled as needed. The positive electrode material mixture layer may be formed on one surface of the positive electrode current collector, or may be formed on both surfaces thereof. The positive electrode material mixture includes the positive electrode active material as an essential component, and can include a binder, a conductive agent, and the like as optional components. As the dispersing medium of the positive electrode slurry, NMP or the like is used.

A lithium-containing composite oxide can be used as the positive electrode active material, for example. Examples thereof include LiₐCOO₂, LiₐNiO₂, LiₐMnO₂, LiₐCo_{b}Ni_{1-b}O₂, LiₐCo_{b}Mi_{1-b}Oc, LiₐNi_{1-b}MbO_{c}, LiₐMn₂O₄, LiₐMn_{2-b}M_{b}O₄, LiMPO₄, and Li₂MPO₄F (M is at least one selected from the group consisting of Na, Mg, Sc, Y, Mn, Fe, Co, Ni, Cu, Zn, Al, Cr, Pb, Sb, and B). Here, a=0 to 1.2, b=0 to 0.9, and c=2.0 to 2.3. Note that the value of a, which represents the molar ratio of lithium, increases or decreases due to charge and discharge.

Among these, it is preferable to use a lithium nickel composite oxide represented by LiₐNi_{b}M_{1-b}O₂ (M is at least one selected from the group consisting of Mn, Co, and Al, 0<a≤1.2, and 0.3≤b≤1). From the viewpoint of increasing the capacity, it is more preferable that 0.85≤b≤1 is satisfied. From the viewpoint of the stability of the crystal structure, LiₐNi_{b}Co_{c}Al_{d}O₂ (0<a≤1.2, 0.85≤b<1, 0<c<0.15, 0<d≤0.1, b+c+d=1) including Co and Al as M is even more preferable.

As the binder and the conductive agent, those shown as the examples for the negative electrode can be used. As the binder, an acrylic resin may be used. As the conductive agent, graphite such as natural graphite and artificial graphite may be used.

The shape and the thickness of the positive electrode current collector can be respectively selected from the shape and the range conforming to the negative electrode current collector. Examples of the material of the positive electrode current collector include stainless steel, aluminum, an aluminum alloy, and titanium.

### [Non-Aqueous Electrolyte]

The non-aqueous electrolyte includes a non-aqueous solvent, and a lithium salt dissolved in the non-aqueous solvent. As the lithium salts, at least LiPF₆ and LFSI are included. The concentration of the lithium salts in the non-aqueous electrolyte is, for example, preferably 0.5 mol/L or more and 2 mol/L or less. By setting the lithium salt concentration within the above-described range, it is possible to obtain a non-aqueous electrolyte having excellent ion conductivity and moderate viscosity. However, the lithium salt concentration is not limited to the above examples.

The non-aqueous electrolyte may include a lithium salt other than LiPF₆ and LFSI. Examples of the lithium salt other than LiPF₆ and LFSI include LiClO₄, LiBF₄, LiAICl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borate salts, and imide salts. Examples of the borate salts include lithium bis(1,2-benzenediolate(2-)-O,O′) borate, lithium bis(2,3-naphthalenediolate(2-)-O,O′) borate, lithium bis(2,2′-biphenyldiolate(2-)-O,O′) borate, and lithium bis(5-fluoro-2-olate-1-benzenesulfonate-O,O′) borate. Examples of the imide salts include lithium bis(trifluoromethanesulfonyl)imide (LiN(CF₃SO₂)₂), lithium trifluoromethanesulfonyl nonafluorobutanesulfonyl imide (LiN(CF₃SO₂)(C₄F₉SO₂)), and lithium bis(pentafluoroethanesulfonyl)imide (LiN(C₂F₅SO₂)₂).

As the non-aqueous solvent, it is possible to use, for example, a cyclic carbonic acid ester, a chain carbonic acid ester, a cyclic carboxylic acid ester, a chain carboxylic acid ester, and the like. Examples of the cyclic carbonic acid ester include propylene carbonate (PC) and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL) and γ-valerolactone (GVL). Examples of the chain carboxylic acid ester include methyl formate, ethyl formate, propyl formate, methyl acetate, ethyl acetate, propyl acetate, methyl propionate, ethyl propionate, and propyl propionate. The non-aqueous solvents may be used alone or in a combination of two or more.

### [Separator]

Usually, it is desirable that a separator is interposed between the positive electrode and the negative electrode. The separator has a high ion permeability, as well as suitable mechanical strength and insulating properties. As the separator, it is possible to use a microporous thin film, a woven fabric, anon-woven fabric, and the like. Polyolefins such as polypropylene and polyethylene are preferable as the material of the separator.

Examples of the structure of the non-aqueous electrolyte secondary battery include a structure in which an electrode group formed by winding a positive electrode and a negative electrode with a separator interposed therebetween, and a non-aqueous electrolyte are housed in an outer package. Alternatively, an electrode group having another configuration, such as a stacked electrode group formed by stacking a positive electrode and a negative electrode with a separator interposed therebetween, may be used in place of the wound electrode group. For example, the non-aqueous electrolyte secondary battery may have any configuration such as a cylindrical configuration, a prismatic configuration, a coin configuration, a button configuration, and a laminated configuration.

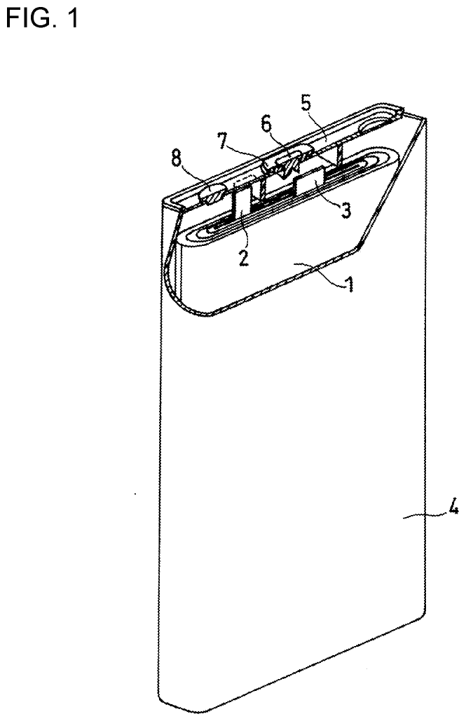

In the following, the structure of a prismatic non-aqueous electrolyte secondary battery as an example of the non-aqueous electrolyte secondary battery according to the present invention will be described with reference to FIG. 1. FIG. 1 is a partially cut-away, schematic oblique view of a non-aqueous electrolyte secondary battery according to an embodiment of the present invention.

The battery includes a bottomed prismatic battery case 4, and an electrode group 1 and a non-aqueous electrolyte (not shown) that are housed in the battery case 4. The electrode group 1 includes a long band-shaped negative electrode, a long band-shaped positive electrode, and a separator that is interposed therebetween and prevents a direct contact therebetween. The electrode group 1 is formed by winding the negative electrode, the positive electrode, and the separator around a flat plate-shaped winding core, and pulling out the winding core.

An end of a negative electrode lead 3 is attached to a negative electrode current collector of the negative electrode through welding or the like. The other end of the negative electrode lead 3 is electrically connected to a negative electrode terminal 6 provided on a sealing plate 5 via an resin insulating plate (not shown). The negative electrode terminal 6 is insulated from the sealing plate 5 by a resin gasket 7. An end of a positive electrode lead 2 is attached to a positive electrode current collector of the positive electrode through welding or the like. The other end of the positive electrode lead 2 is connected to a back surface of the sealing plate 5 via an insulating plate. That is, the positive electrode lead 2 is electrically connected to the battery case 4 also serving as a positive electrode terminal. The insulating plate isolates the electrode group 1 and the sealing plate 5 from each other and also isolates the negative electrode lead 3 and the battery case 4 from each other. A peripheral edge of the sealing plate 5 is fitted to an opening end portion of the battery case 4, and the fitted portion is laser welded. In this manner, an opening of the battery case 4 is sealed by the sealing plate 5. An non-aqueous electrolyte injection hole formed in the sealing plate 5 is closed by a sealing plug 8.

### EXAMPLES

Hereinafter, the present invention will be specifically described by way of examples. However, the present invention is not limited to the following examples.

### Example 1

### [Preparation of First Composite Material (LSX Material)]

Silicon dioxide and lithium carbonate were mixed such that the atomic ratio: Si/Li was 1.05, and the mixture was fired at 950° C. in the air for 10 hours, to obtain lithium silicate represented by Li₂Si₂O₅ (z=½). The obtained lithium silicate was ground so as to have an average particle size of 10 μm.

The lithium silicate (Li₂Si₂O₅) having an average particle size of 10 μm and a silicon raw material (3N, average particle size: 10 μm) were mixed at amass ratio of 45:55. The mixture was filled into a pot (made of SUS, volume: 500 mL) of a planetary ball mill (P-5, manufactured by Fritsch Co., Ltd.), then 24 SUS balls (diameter: 20 mm) were placed in the pot, and the cover was closed. Then, the mixture was ground at 200 rpm for 50 hours in an inert atmosphere.

Next, the mixture in the form of powder was taken out in the inert atmosphere, and was fired at 800° C. for 4 hours, with a pressure was applied thereto using a hot pressing machine in the inert atmosphere, thus obtaining a sintered body (LSX material) of the mixture.

Thereafter, the LSX material was ground, then passed through a 40 μm mesh, and thereafter the resulting LSX particles were mixed with coal pitch (MCP 250, manufactured by JFE Chemical Corporation). Then, the mixture was fired at 800° C. in an inert atmosphere, thus forming, on the surface of the LSX particles, a conductive layer including a conductive carbon. The coating amount of the conductive layer was 5 mass % to the total mass of the LSX particles and the conductive layer. Thereafter, using a sieve, LSX particles each including a conductive layer and having an average particle size of 5 μm were obtained.

The average particle size of the silicon particles as determined by the method described previously was 100 nm. An XRD analysis of the LSX particles indicated that the crystallite size of the silicon particles calculated from the diffraction peak attributed to the Si (111) plane using the Scherrer equation was 15 nm.

As a result of conducting an AES analysis for the lithium silicate phase, the composition of the lithium silicate phase was Li₂Si₂O₅. The content of the silicon particles in the LSX particles as measured by Si-NMR was 55 mass % (the content of Li₂Si₂O₅ was 45 mass %).

### [Fabrication of Negative Electrode]

Water was added to the negative electrode material mixture, and thereafter the whole was stirred using a mixer (T.K.HIVIS MIX manufactured by PRIMIX Corporation), to prepare a negative electrode slurry. As the negative electrode material mixture, a mixture of a negative electrode active material, a CNT (average diameter: 9 nm, average length: 12 μm), a lithium salt of polyacrylic acid (PAA-Li), sodium carboxymethyl cellulose (CMC-Na), and a styrene-butadiene rubber (SBR) was used. In the negative electrode material mixture, the mass ratio of the negative electrode active material, the CNT, the CMC-Na, and the SBR was 100:0.3:0.9:1.

As the negative electrode active material, a mixture of a silicon-containing material and graphite was used. Of the first composite material and the second composite material, at least the first composite material was used as the silicon-containing material. As the first composite material, the LSX particles obtained as above were used. As the second composite material, SiO particles (x=1, average particle size of silicon particles: about 5 nm) having an average particle size of 5 μm were used.

In the negative electrode material mixture, the value of the mass ratio X of the first composite material to the total of the first composite material and the second composite material was as shown in Table 1. In the negative electrode material mixture, the value of the mass ratio Y of the total of the first composite material and the second composite material to the total of the first composite material, the second composite material, and the graphite was as shown in Table 1.

Next, the negative electrode slurry was applied to a surface of a copper foil such that the mass per m² of the negative electrode material mixture was 140 g, and the resulting coating film was dried, and thereafter rolled, to form a negative electrode material mixture layer having a density 1.6 g/cm³. The negative electrode material mixture layer was formed on both surfaces of the copper foil, to obtain a negative electrode.

### [Fabrication of Positive Electrode]

A lithium nickel composite oxide (LiNi_{0.8}Co_{0.18}Al_{0.02}O₂), acetylene black, and polyvinylidene fluoride were mixed at amass ratio of 95:2.5:2.5, and N-methyl-2-pyrrolidone (NMP) was added thereto. Thereafter, the mixture was stirred using a mixer (T.K.HIVIS MIX manufactured by PRIMIX Corporation), to prepare a positive electrode slurry. Next, the positive electrode slurry was applied to a surface of an aluminum foil, and the resulting coating film was dried, and thereafter rolled, to form a positive electrode material mixture layer having a density of 3.6 g/cm³. The positive electrode material mixture layer was formed on both surfaces of the aluminum foil, to obtain a positive electrode.

### [Preparation of Non-Aqueous Electrolyte]

A non-aqueous electrolyte was prepared by dissolving lithium salts in a non-aqueous solvent. As the non-aqueous solvent, a solvent mixture (volume ratio 3:7) of ethylene carbonate (EC) and dimethyl carbonate (DMC) was used. As the lithium salts, LiPF₆ and LFSI were used. The concentration of the LiPF₆ in the non-aqueous electrolyte was 0.95 mol/L. The concentration of the LFSI in the non-aqueous electrolyte was 0.4 mol/L.

### [Fabrication of Non-Aqueous Electrolyte Secondary Battery]

A tab was attached to each of the electrodes, and the positive electrode and the negative electrode were spirally wound with a separator interposed therebetween such that the tabs were located at the outermost peripheral portion, to fabricate an electrode group. Batteries A1 to A90 were each fabricated by inserting the electrode group into an outer package made of an aluminum laminate film, vacuum drying the whole at 105° C. for 2 hours, thereafter injecting the non-aqueous electrolyte into the outer package, and sealing the opening of the outer package.

Batteries C1 to C90 were fabricated in the same manner as the batteries A1 to A90, respectively, except that LFSI was not included in the non-aqueous electrolyte.

### [Evaluation 1]

The battery A1 was subjected to the following charge and discharge cycle test.

The battery was subjected to constant current charge at a current of 0.3 It until a voltage of 4.2V was reached, and thereafter subjected to constant voltage charge at a voltage of 4.2 V until a current of 0.015 It was reached. Thereafter, the battery was subjected to constant current discharge at a current of 0.3 It until a voltage of 2.75 V was reached. The rest period between charge and discharge was 10 minutes. Charge and discharge were performed under a 25° C. environment.

Note that (1/X) It represents a current, (1/X) It (A) is a rated capacity (Ah)/X(h), and X represents the time required to charge or discharge the amount of electricity corresponding to the rated capacity. For example, 0.5 It means that X=2, and the current value is equal to a rated capacity (Ah)/2(h).

Charge and discharge were repeated under the above-described conditions. The proportion (percentage) of the discharge capacity at the 300th cycle to the discharge capacity at the 1st cycle was determined as a capacity maintenance ratio R_{A1}.

For a battery C1 having the same configuration as the battery A1 except that the non-aqueous electrolyte did not include LFSI, a capacity maintenance ratio R_{C1} was determined in the same manner as described above. Using the determined R_{A1} and R_{C1}, the rate of change of the capacity maintenance ratio of the battery A1 to the capacity maintenance ratio of the battery C1 (hereinafter simply referred to as “the rate of change of the capacity maintenance ratio of the battery A1”) was determined by the following expression. In this manner, the change in the capacity maintenance ratio by the addition of LFSI was examined.

Rate of change of capacity maintenance ratio of battery A1(%)=(R_{A1}−R_{C1})/R_{C1}×100

Similarly, using the batteries A2 to A90 and the batteries C2 to C90, the rate of change of the capacity maintenance ratio of each of the batteries A2 to A90 was determined.

The evaluation results are shown in Table 1. The numerical value (percent) in each cell in Table 1 indicates the rate of change of the capacity maintenance ratio, and the reference numeral in each parenthesis indicates the battery number. For example, the cell of the battery A1 indicates the rate of change of the capacity maintenance ratio of the battery A1.

TABLE 1

| | | Mass ratio X | | | | | | | | |
|---|---|---|---|---|---|---|---|---|---|---|
| | | 0.2 | 0.3 | 0.4 | 0.5 | 0.6 | 0.7 | 0.8 | 0.9 | 1 |
| Mass ratio Y | 0.06 | 0.100% | 0.260% | 0.419% | 0.578% | 0.738% | 0.897% | 1.056% | 1.216% | 1.375% |
| | | (A81) | (A71) | (A61) | (A51) | (A41) | (A31) | (A21) | (A11) | (A1) |
| | 0.07 | ≤0.005% | 0.066% | 0.225% | 0.384% | 0.544% | 0.703% | 0.862% | 1.022% | 1.181% |
| | | (A82) | (A72) | (A62) | (A52) | (A42) | (A32) | (A22) | (A12) | (A2) |
| | 0.08 | ≤0.005% | ≤0.005% | 0.072% | 0.231% | 0.390% | 0.550% | 0.709% | 0.868% | 1.028% |
| | | (A83) | (A73) | (A63) | (A53) | (A43) | (A33) | (A23) | (A13) | (A3) |
| | 0.09 | ≤0.005% | ≤0.005% | ≤0.005% | 0.108% | 0.267% | 0.426% | 0.586% | 0.745% | 0.904% |
| | | (A84) | (A74) | (A64) | (A54) | (A44) | (A34) | (A24) | (A14) | (A4) |
| | 0.10 | ≤0.005% | ≤0.005% | ≤0.005% | 0.007% | 0.166% | 0.326% | 0.485% | 0.644% | 0.804% |
| | | (A85) | (A75) | (A65) | (A55) | (A45) | (A35) | (A25) | (A15) | (A5) |
| | 0.11 | ≤0.005% | ≤0.005% | ≤0.005% | ≤0.005% | 0.083% | 0.242% | 0.402% | 0.561% | 0.720% |
| | | (A86) | (A76) | (A66) | (A56) | (A46) | (A36) | (A26) | (A16) | (A6) |
| | 0.12 | ≤0.005% | ≤0.005% | ≤0.005% | ≤0.005% | 0.013% | 0.173% | 0.332% | 0.491% | 0.651% |
| | | (A87) | (A77) | (A67) | (A57) | (A47) | (A37) | (A27) | (A17) | (A7) |
| | 0.13 | ≤0.005% | ≤0.005% | ≤0.005% | ≤0.005% | ≤0.005% | 0.114% | 0.273% | 0.432% | 0.592% |
| | | (A88) | (A78) | (A68) | (A58) | (A48) | (A38) | (A28) | (A18) | (A8) |
| | 0.14 | ≤0.005% | ≤0.005% | ≤0.005% | ≤0.005% | ≤0.005% | 0.064% | 0.223% | 0.382% | 0.542% |
| | | (A89) | (A79) | (A69) | (A59) | (A49) | (A39) | (A29) | (A19) | (A9) |
| | 0.15 | ≤0.005% | ≤0.005% | ≤0.005% | ≤0.005% | ≤0.005% | 0.021% | 0.180% | 0.339% | 0.499% |
| | | (A90) | (A80) | (A70) | (A60) | (A50) | (A40) | (A30) | (A20) | (A10) |

*The numerical value (percent) in each cell indicates the rate of change of the capacity maintenance ratio. The reference numeral in each parenthesis indicates the battery number.

When the LFSI concentration in the non-aqueous electrolyte was 0.4 mol/L, the batteries A1 to A9, A11 to A16, A21 to A24, A31 to A33, A41 to A42, and A51, which satisfy the relational expression (1), had a rate of change of the capacity maintenance ratio of 0.5% or more, indicating significantly improved cycle characteristics. Among these, the batteries A1 to A3, A11 to A12, and A21, which satisfy the relational expression (2), had a rate of change of the capacity maintenance ratio of 1% or more, indicating further improved cycle characteristics.

### Example 2

Batteries B1 to B90 were fabricated in the same manner as the batteries A1 to A90, respectively, except that the LFSI concentration in the non-aqueous electrolyte was 0.2 mol/L, and that the LiPF₆ concentration in the non-aqueous electrolyte was 1.15 mol/L.

### [Evaluation 2]

The capacity maintenance ratio R_{B1} of the battery B1 was determined in the same manner as described above. Using the determined capacity maintenance ratio R_{B1} of the battery B1 and the capacity maintenance ratio R_{C1} of the battery C1 having the same configuration as the battery B1 except that the non-aqueous electrolyte does not include LFSI, the rate of change of the capacity maintenance ratio of the battery B1 was determined by the following expression:

Rate of change of capacity maintenance ratio of battery B1(%)=(R_{B1}−R_{C1})/R_{C1}×100

Similarly, using the batteries B2 to B90 and the batteries C2 to C90, the rate of change of the capacity maintenance ratio of each of the batteries B2 to B90 was obtained.

The evaluation results are shown in Table 2. The numerical value (percent) in each cell in Table 2 indicates the rate of change of the capacity maintenance ratio, and the reference numeral in each parenthesis indicates the battery number. For example, the cell of the battery B1 indicates the rate of change of the capacity maintenance ratio of the battery B1.

TABLE 2

| | | Mass ratio X | | | | | | | | |
|---|---|---|---|---|---|---|---|---|---|---|
| | | 0.2 | 0.3 | 0.4 | 0.5 | 0.6 | 0.7 | 0.8 | 0.9 | 1 |
| Mass ratio Y | 0.06 | 0.050% | 0.130% | 0.210% | 0.289% | 0.369% | 0.449% | 0.528% | 0.608% | 0.688% |
| | | (B81) | (B71) | (B61) | (B51) | (B41) | (B31) | (B21) | (B11) | (B1) |
| | 0.07 | ≤0.005% | 0.033% | 0.112% | 0.192% | 0.272% | 0.351% | 0.431% | 0.511% | 0.590% |
| | | (B82) | (B72) | (B62) | (B52) | (B42) | (B32) | (B22) | (B12) | (B2) |
| | 0.08 | ≤0.005% | ≤0.005% | 0.036% | 0.115% | 0.195% | 0.275% | 0.355% | 0.434% | 0.514% |
| | | (B83) | (B73) | (B63) | (B53) | (B43) | (B33) | (B23) | (B13) | (B3) |
| | 0.09 | ≤0.005% | ≤0.005% | ≤0.005% | 0.054% | 0.134% | 0.213% | 0.293% | 0.373% | 0.452% |
| | | (B84) | (B74) | (B64) | (B54) | (B44) | (B34) | (B24) | (B14) | (B4) |
| | 0.10 | ≤0.005% | ≤0.005% | ≤0.005% | 0.004% | 0.083% | 0.163% | 0.243% | 0.322% | 0.402% |
| | | (B85) | (B75) | (B65) | (B55) | (B45) | (B35) | (B25) | (B15) | (B5) |
| | 0.11 | ≤0.005% | ≤0.005% | ≤0.005% | ≤0.005% | 0.041% | 0.121% | 0.201% | 0.281% | 0.360% |
| | | (B86) | (B76) | (B66) | (B56) | (B46) | (B36) | (B26) | (B16) | (B6) |
| | 0.12 | ≤0.005% | ≤0.005% | ≤0.005% | ≤0.005% | 0.007% | 0.086% | 0.166% | 0.246% | 0.325% |
| | | (B87) | (B77) | (B67) | (B57) | (B47) | (B37) | (B27) | (B17) | (B7) |
| | 0.13 | ≤0.005% | ≤0.005% | ≤0.005% | ≤0.005% | ≤0.005% | 0.057% | 0.137% | 0.216% | 0.296% |
| | | (B88) | (B78) | (B68) | (B58) | (B48) | (B38) | (B28) | (B18) | (B8) |
| | 0.14 | ≤0.005% | ≤0.005% | ≤0.005% | ≤0.005% | ≤0.005% | 0.032% | 0.111% | 0.191% | 0.271% |
| | | (B89) | (B79) | (B69) | (B59) | (B49) | (B39) | (B29) | (B19) | (B9) |
| | 0.15 | ≤0.005% | ≤0.005% | ≤0.005% | ≤0.005% | ≤0.005% | 0.010% | 0.090% | 0.170% | 0.249% |
| | | (B90) | (B80) | (B70) | (B60) | (B50) | (B40) | (B30) | (B20) | (B10) |

*The numerical value (percent) in each cell indicates the rate of change of the capacity maintenance ratio. The reference numeral in each parenthesis indicates the battery number.

When the LFSI concentration in the non-aqueous electrolyte was 0.2 mol/L, the batteries B1 to B9, B11 to B16, B21 to B24, B31 to B33, B41 to B42, and B51, which satisfy the relational expression (1), had a rate of change of the capacity maintenance ratio of 0.25% or more, indicating significantly improved cycle characteristics. Among these, the batteries B1 to B3, B11 to B12, and B21, which satisfy the relational expression (2), had a rate of change of the capacity maintenance ratio of 0.5% or more, indicating further improved cycle characteristics.

### INDUSTRIAL APPLICABILITY

The non-aqueous electrolyte secondary battery according to the present invention is useful as a main power source for mobile communication devices, mobile electronic devices, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1. . . . Electrode group
2. . . . Positive electrode lead
3. . . . Negative electrode lead
4. . . . Battery case
5. . . . Sealing plate
6. . . . Negative electrode terminal
7. . . . Gasket
8. . . . Sealing plug

1. A non-aqueous electrolyte secondary battery comprising:
a positive electrode; a negative electrode; and a non-aqueous electrolyte,
wherein the negative electrode includes a negative electrode material mixture including: a negative electrode active material including a silicon-containing material and a carbon material; and a carbon nanotube,
the silicon-containing material includes, of a first composite material and a second composite material, at least the first composite material,
the first composite material includes a lithium ion conductive phase, and silicon particles dispersed in the lithium ion conductive phase, the lithium ion conductive phase including a silicate phase and/or a carbon phase, the silicate phase including at least one selected from the group consisting of alkali metal elements and Group 2 elements,
the second composite material includes a SiO₂ phase, and silicon particles dispersed in the SiO₂ phase,
a mass ratio X of the first composite material to a total of the first composite material and the second composite material, and a mass ratio Y of the total of the first composite material and the second composite material to a total of the first composite material, the second composite material, and the carbon material satisfy a relational expression (1):
100Y−32.2X⁵+65.479X⁴−55.832X³+18.116X²−6.9275X−3.5356<0,
X≤1, and 0.06≤Y, and
the non-aqueous electrolyte includes lithium hexafluorophosphate and lithium bis(fluorosulfonyl)imide: LFSI.

2. The non-aqueous electrolyte secondary battery according to claim 1,
wherein the mass ratio X and the mass ratio Y satisfy a relational expression (2):
100Y−2.1551×exp(1.3289X)<0,
X≤1, and 0.06≤Y.

3. The non-aqueous electrolyte secondary battery according to claim 1,
wherein the carbon material includes graphite.

4. The non-aqueous electrolyte secondary battery according to claim 1,
wherein a content of the carbon nanotube in the negative electrode material mixture is 0.1 mass % or more and 0.5 mass % or less, relative to a whole of the negative electrode material mixture.

5. The non-aqueous electrolyte secondary battery according to claim 1,
wherein a concentration of the LFSI in the non-aqueous electrolyte is 0.2 mol/L or more.

6. The non-aqueous electrolyte secondary battery according to claim 1,
wherein a concentration of the LFSI in the non-aqueous electrolyte is 0.2 mol/L or more and 0.4 mol/L or less.
